(19) United States
(12) Patent Application Publication
(10) Pub. No.: US 2002/0188679 A1
(43) Pub. Date: Dec. 12, 2002

(54) Computer implemented method and apparatus providing self-directed online interactive experiences

(76) Inventors: Anthony G. Matous, Saltsburg, PA (US); Bruce A. Moser, Indiana, PA (US)

Correspondence Address: CAROTHERS AND CAROTHERS, Suite 500, 445 Fort Pitt Blvd., Pittsburgh, PA, 15219, US

(21) Appl. No.: 09/875,468

(22) Filed: Jun. 6, 2001

(51) Int. Cl. G06F 15/16; G09B 7/00

(52) U.S. Cl. 709/204; 434/323; 707/104.1

(57) ABSTRACT

A computer implemented method and apparatus providing a self-directed online interactive experience, such as a learning experience or a game playing experience, by multiple participant users on user general purpose computers that are coupled to a global computer network. A host computer system is also coupled to the network and is provided with a storage medium storing a database of interactive experiences. The host computer system is programmed for multithreaded access of the host computer database whereby multiple participant users may simultaneously access and participate in the dynamically stored interactive experiences. The host computer system is further programmed for providing navigation capabilities in the host computer system whereby a participant user may selectively navigate the host learning management system. It is further preferred that the host computer system be programmed for providing index capabilities in the host computer system whereby a participant user may exit participation at any desired time and will be automatically returned to the place of termination upon re-accessing of the database by the participant user for continued participation.

### FIELD OF THE INVENTION

This invention relates to a method and apparatus for providing self-directed online interactive experiences, such as, learning or game playing.

### DEFINITION OF TERMS

1. General Purpose Computer

An individually owned or accessed computer which includes, but is not limited to, a central processing unit (CPU), random access memory (RAM), persistent storage media, an input/output adapter for connecting peripheral devices, a user interface adapter for connecting a keyboard, a mouse, speakers and/or other similar devices, and an interface to a telecommunication network.

2. Memory Device

Random access memory and/or read only memory for a general purpose computer.

3. Display Device

A video screen for a general purpose computer.

4. Network

A telecommunication network and/or the Internet or the global computer network.

5. Database

An information storage system, using relational structures and indexing to provide quick access to data.

6. Host Computer

A computer system used by one hosting the interactive experiences that includes the additional functional ity that permits it to operate as a web server.

7. Interactive Experiences

Educational or game playing experiences that are personalized to the participating user.

8. Multithreading

Multiple processes being executed concurrently on one central processing unit.

9. Navigation Capabilities

The capability of accessing desired or selected areas of the host computer database and/or website by a participant user, and to also include the ability to move from screen to screen within a delivered sequence of screens.

10. Storage Medium

A device attached to a computer system that is capable of long or short-term storage of data and includes memory devices. The device stores or retrieves data as directed by the computer system.

11. Encoded

A transforming of information into binary code understandable or transferable by computer.

12. Machine-Readable Computer Program Code

Information encoded as defined in the previous definition.

13. Custom Delivery System (CDS)

The online component (such as a shell) that acts as a mediator between database information and the student or user.

14. Course Management Database

A database that tracks the user, system, course, sequence and screen information.

15. ColdFusion Script Pages

Scripts that provide further mediation between the user and the course management database, where Macromedia Flash action scripts are incapable of performing the necessary tasks.

16. Screens

Individually created Flash animation that convey one or more detailed concepts.

17. Movies

A series of linear frames that produce fluid content when viewed beginning to end at a relatively constant rate.

18. Sequences

A series of screens placed in order using the course management system of the present invention to convey a broader concept of that conveyed in an individual screen.

19. Course

A series of sequences placed in order using the course management system to convey a broader concept than that conveyed in an individual sequence.

20. Glossary Terms and Definitions

Terms and definitions pertaining to one or more courses. These are entered into the Course Management Database utilizing the course management system. The terms and definitions are then accessible by the Custom Delivery Shell and thus to the student.

21. Linkset

A set of http addresses pertaining to one or multiple courses. These are entered into the Course Management Database utilizing the course management system of the present invention. The http addresses are then accessible by the Custom Delivery Shell and thus to the student via the World Wide Web.

22. Index

A system of storage and retrieval that allows for random access to any one core component of data and includes bookmark capabilities.

23. Electronic Collaborative Communication

A means of communication where individuals discuss topics through electronic mediums (e.g. Chat, Threaded Discussion, Flowing Discussion) and a user's communications are visible to other individuals, thus allowing for a multi-person discussion instead of a dialog.

### BACKGROUND OF THE INVENTION

Present day computer implemented methods and apparatus for providing experiences to remote user participants applying general purpose computers for the purpose of learning or game playing do not provide sufficient self-directed online interactive experiences, and thereby do not provide learning or game experiences that can attain maximum entertainment, satisfaction and results for the user participants.

### SUMMARY OF THE INVENTION

This specification describes a Course Delivery System of the present invention. The Course Delivery System is described in a linear nature due to the non-expressive capabilities of the written word. The Course Delivery System, however, is concurrent and simultaneous in nature. The later detailed Initialization and Delivery Phases of the system occur concurrently and without regard to each other except where described. This ability to accomplish multiple activities at the same instance is what makes the system effective and unique.

The computer implemented method and apparatus of the present invention provides a participant user with self-directed online interactive experiences, such as learning experiences or game playing experiences, by multiple participants on multiple general purpose computers. These general purpose computers include a memory device and a display device and they are coupled to a telecommunication network. In addition, a host computer system is also coupled to the network and is provided with a storage medium storing a database of interactive experiences. The user general purpose computers are coupled through their network to the host computer system for displaying user selected interactive experiences from the host database for interactive user participation in a selected experience.

The host computer system is programmed for multithreaded access of the host database whereby multiple participant user computers may simultaneously access and participate in the dynamically stored interactive experiences. The host computer system is further programmed for providing navigation capabilities in the host computer system whereby a participant user on a user computer may selectively navigate the host management system programmed into the host computer. Additionally, the host computer system may be further programmed for providing index capabilities in the host computer system whereby a participant user may exit participation at any desired time and will automatically be returned to the place of termination upon re-accessing of the website by the participant user for continued participation.

The interactive experiences may be experiences for a learning management system for students of any learning level, or the interactive experiences may be game playing experiences for an interactive game delivery system. However, the method and apparatus of the present invention will be explained in terms of learning experiences by way of example in view of the fact that the range of learning experiences is considered to be much broader than interactive experiences that may be encountered by game playing experiences. It is believed that a better and easier understanding of the present invention can be explained in conjunction with learning experiences as opposed to game playing experiences. Also, the course management system is believed to contain additional inventive features of the present invention in regard to course deliver content.

In accordance with more detailed teachings of the present invention, the desired learning experiences to be encountered in the course management system of the present invention include learning course component experiences comprised of Learn, Complete Course Work, Demonstrate Knowledge, Self-Evaluation and Share Course Work. In the complete course delivery system all of these component experiences will be provided to the participant user and generally in the sequence indicated. This, of course, is all accomplished remotely by each student on his or her general purpose computer.

The Learn component of these course component learning experiences may also include one or more course selections comprised of: Course Objectives outline, provision of Learning Materials, Tools for navigating selected portions of the host computer database and management system, and display of Concept Presentation. The course section entitled Concept Presentation, may include concepts selected from the group consisting of Engaging interaction, A website visit, A real-world simulation hard copy documentation including standards, and Electronic collaborative communications. All of these components work together to provide a remotely located student an entertaining and effective self-directed online interactive learning experience not heretofore possible.

A learning management system is provided that supplies education through online delivery of courses over a computer network whereby the participant user of the learning system is presented with an interactive educational experience: that is personalized to the participant user. The learning system of the present invention utilizes a combination of several components, including a website, graphics, animation, audio, and database tracking in order to dynamically present educational material. Students are provided the opportunity to select courses from a variety of subjects, depending upon their educational needs and individual user portfolios of completed courses and course work, a searchable collection of course work, peer reviews, and threaded discussions are also components that are integrated into the learning system of the present invention. The student is thus furnished with the ability to enjoy a self-directed educational experience with the advantage that the student is able to navigate through the learning system at a pace controlled by the student, with all students having simultaneous access to the dynamic learning experiences, thereby permitting the students to complete the individualized learning experience when it is convenient for the student.

### BRIEF DESCRIPTION OF THE DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 is a schematic block diagram providing a diagrammatic overview of the computer system utilized to practice the method and apparatus of the present invention;

FIG. 2 is a schematic block diagram illustrating the computer implemented method and apparatus of the present invention for self-directed online interactive experiences illustrated in the form of learning experiences for a learning course delivery system;

FIG. 3 is a flow chart illustrating the initialization procedure carried out in the host computer system which implements the self-directed online interactive course delivery system illustrated in FIG. 2;

FIG. 4 is a flow chart illustrating the delivery mode procedure carried out in the host computer system illustrated in FIG. 2; and

FIG. 5 is a life span flow chart illustrating the sequential steps carried out by the host computer system performing the computer implemented learning course delivery system of the present invention.

### DETAILED DESCRIPTION OF A PREFERRED EMBODIMENT

The present invention pertains to a computer implemented method and apparatus for providing self-directed online interactive experiences such as learning experiences or game playing experiences by multiple participants on user general purpose computers. While the method and apparatus of the present invention pertains to self-directed online interactive experiences in general, this description of the preferred embodiment will be described in terms of a learning management system for learning experiences.

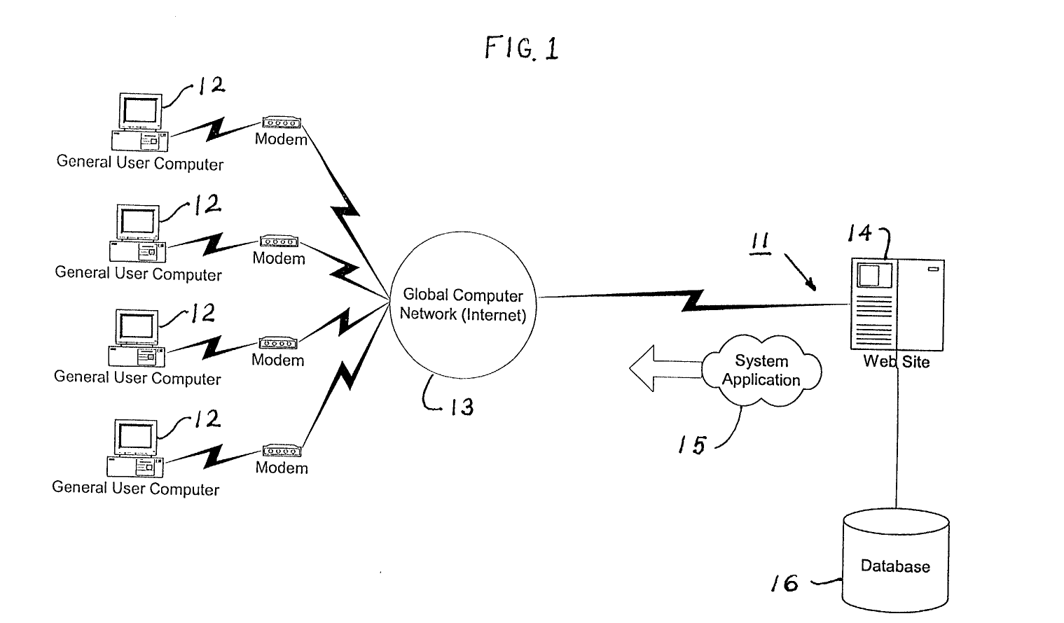

The learning management system of the present invention is a computer based educational system that offers participant users or students an educational opportunity that is obtained online through a variety of different courses. FIG. 1 illustrates the main components of the learning system 10 that includes a host computer system 11 connected to multiple user general purpose computers 12 through the global computer network 13. A participant user may access the host computer system 11 on one of the general user computers 12 and thereby access the website 14 of the learning management system. From the website 14, the participant user may then access the different courses and other features of the host computer 11 wherein the user general purpose computer then retrieves and executes the custom delivery system (CDS) application 15.

By way of example, the general purpose computers 12 can be an IBM compatible personal computer, an Apple Macintosh computer, a UNIX based work station or any other similar type of general purpose computer. As explained in the definitions, the general user computers 12 include a central processing unit, random access memory, a persistent storage medium, and an interface to a telecommunication network shown here in the form of global computer network 13. The general user computers 12 will also have a resident operating system, such as, a Microsoft Windows based OS, MAC OS, UNIX OS or any other type of readily available operating system. In addition, the general user computers are also able to execute a computer based global computer network interface which is sometimes referred to as World Wide Web browser in order for the participant users to access the website 14 of the host computer system 11.

The host computer system 11 also uses a general purpose computer, but with additional functionality that permits it to operate as a web server. As a variation, the host computer system 11 can be in the form of several computers connected together to accomplish the functions and operations of the learning system of the present invention. For example, the web server functions can be executed on one computer that is then connected to another computer which executes the corresponding code for the website 14 and the CDS application 15, which in turn can be connected to a third computer that stores the information in a central database 16.

Each web page of the website 14 serves as a mechanism for interaction with a student operating one of the general user computers 12. Some of the web pages can be highly interactive by requesting information from the participant user and providing feedback. Other web pages within website 14, can be less complex and are simply used for information delivery and/or collection from the participant user. Also, in order to limit errors, many of the web pages are designed to identify and alert participant users of missing and/or incorrect information as well as general errors.

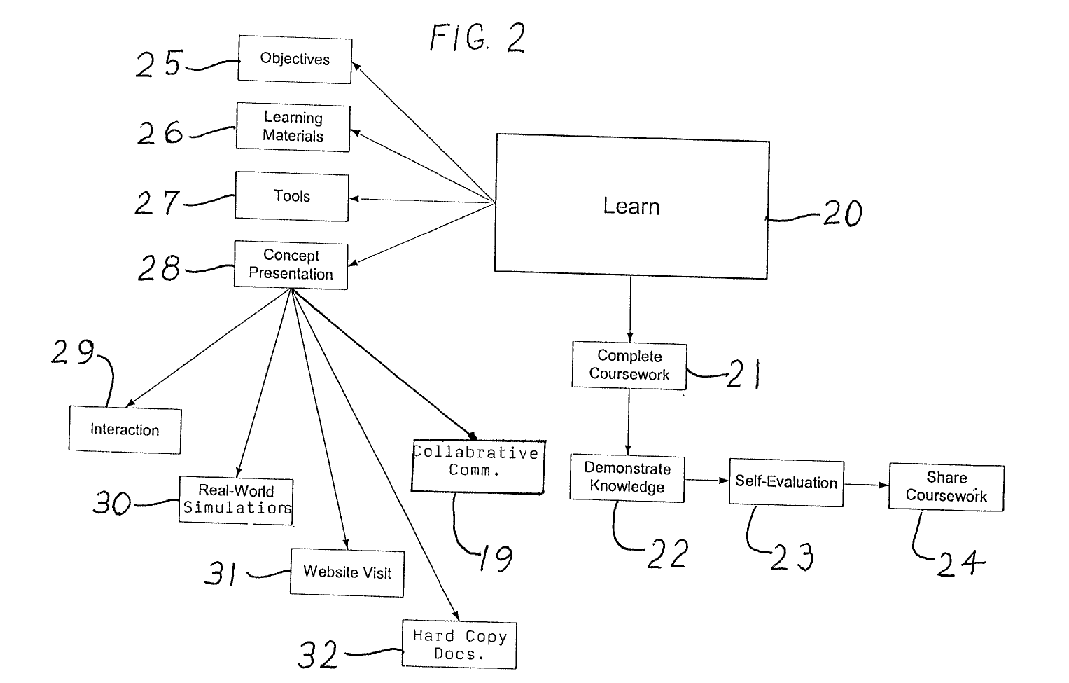

The programming of the learning management system of the host computer system 11 is diagrammatically illustrated in FIG. 2 and provides a very open-ended environment that permits the participant user to navigate along a number of different paths. The purpose of the learning system is to provide students with a computer based educational experience that is unique and interactive. The learning system utilizes a combination of components in order to dynamically present courses in a format that resembles a one-on-one seminar, but yet allows the student to start and stop the course at their leisure. Multiple participant users or students are also permitted to simultaneously access and participate in the dynamic stored interactive learning experiences and the system is very much directed by the online participant user who is permitted to selectively navigate the host learning management system including the database without regard to other online participants. The website 14 provides general reference information and operates as a medium to assist students in accessing a variety of utilities available on the website 14. Some of the utilities included in the website are utilities for creating and accessing accounts, purchasing and enrolling in courses, viewing course progress, submitting course work, accessing transcripts, participating in online discussions, browsing the course work of others and purchasing educational materials.

Upon accessing the website 14, the participant user is then able to link to different web pages to access the resources and information included throughout the World Wide Web.

With particular reference to FIG. 2, courses for the student provided within this learning system are presented using a five component format. The five components include Learn 20, Complete Course Work 21, Demonstrate Knowledge 22, Self-Evaluation 23 and Share Course Work 24. Each of the five components represents a unique portion of the learning system.

As is also illustrated in FIG. 2, the Learn component 20 consists of a number of sections. As students progress sequentially through the sections they will encounter Course Objectives 25 that are outlined, Learning Materials 26 that are provided, Tools 27 that are accessible in the host computer and Concept Presentation 28 wherein concepts are displayed. These displayed concepts include, but are not limited to, Interactions 29, Real-World Simulations 30, Website Visits 31, Hard Copy Documentation 32 and Electronic Collaborative Communications 19.

In the Learn component 20 of the system, the courses are delivered to the student using a series of movie-like screens that combine audio with synchronized text and graphics to illustrate the course content. In order to facilitate learning, each screen is designed to be visually appealing, to flow and transition smoothly, and to end by leaving the student with enough information to immediately recall what the screen was about.

A learning course begins by outlining clear-cut objectives for the student by accessing Course Objectives 25. As students progress through a course, they are provided with the ability to freely move or navigate through any screens that they have already completed. Therefore, if a student loses sight of the objectives while progressing through the course, the opportunity always exists to return to the beginning and view the objectives screen again of Course Objectives 25.

In section 26, Learning Materials, the students, after viewing the objectives, are furnished with learning materials that contain thought provoking statements and questions. Learning Materials serves as a guide for the students as they progress through the course. The content of the Learning Materials parallels the content of the course, which helps to reiterate the important concepts and strengthen the student's understanding of the material. Also, once the student completes the course, the Learning Materials become a valuable resource for further reference by many users.

Throughout the course, the student has access to a tool set as provided in section 27, Tools. These Tools include:

1 . Table of contents that could be used to navigate through the screens that have already been viewed;

2 . Searchable glossary, which includes words that are also highlighted and accessible from within the course content; and

3. Listing of additional resources that relate to the course content.

In section 28, Concept Presentation, the concepts presented in a course are presented in a clear and concise manner that is easy for the student to understand. The goal is to present concepts in such a way that the student will have the ability to apply the concepts immediately upon completion of the course. Fonts, titles, icons, and color schemes, are consistent for each concept presented. Uniformity and consistency are important aspects of Concept Presentation because they enhance the ability of the student to differentiate between all the concepts presented within a course and recall the concepts once they have completed a course. Every four to six screens during concept presentation the student is presented with an engaging Interaction 29, Website Visit 31, Real-World Simulation sequence 30 or Electronic Collaborative Communications 19.

Interaction 29 includes activities that require the student to practice using the concept that is being presented. The student must interact with the computer in some way, such as typing answers in a specified area or dragging an object and dropping in the correct location. Interactions contain clear, easy to follow instructions, and always leave the student with the correct answer. Real-World Simulations 30 sequences consist of a continuous series of screens that resemble a short film. The simulations demonstrate scenarios in which the concepts are being used in a real-world situation. Website Visits 31 requires the student to visit a site on the World Wide Web and complete a supplemental reading assignment that will enhance what is taught in the course content. In Hard Copy Documentation 32, situations are provided wherein the concepts presented in a course address a set of specific information. A unique visual element is placed on the screen where the Hard Copy Documentation is addressed to alert the student. This feature allows the student to easily determine which concepts can be used to meet certain standards upon completion of the course.

Thereafter, once the Learn component 20 is completed, the student then begins the Complete Course Work component 21. In this component, the student is expected to complete specific activities based on the concepts and ideas presented within the course content. The student completes this stage by utilizing an interface. This interface presents the required tasks in an informative and logical format that reinforces the concepts that were covered during the Learn stage. Dynamically driven by the Database on the host system, responses are stored in the same database through use of HTML forms.

Thereafter, the Demonstrate Knowledge component 22 is encountered by the student and provides the student with the opportunity to apply the skills they learned within the course. Requiring students to demonstrate what they have learned facilitates increased retention and a higher level of performance. The demonstration can be performed in several ways to include completion of testing materials or implementation of the skills in a real-world setting. This could be accomplished through activities, exams, and/or applications.

After the student has demonstrated their knowledge, they are then exposed to component Self-Evaluation 23, wherein they are asked to perform self-evaluation. In this component, students are required to reflect on the success or failure of the implementation of their course work. This section challenges students to learn from their mistakes and to achieve a higher level of competency.

Lastly, the student must complete component 24 which is the Share Course Work component. This component of the learning system promote openness to new ideas and different perspectives by encouraging students to share their course work with their peers. Students share their completed course work with others by submitting it to a database. The information in the database consists of course work developed by students using the previously outlined learning system. This sharing of course work results in a collection of valuable resources that are accessible by all students utilizing the learning system.

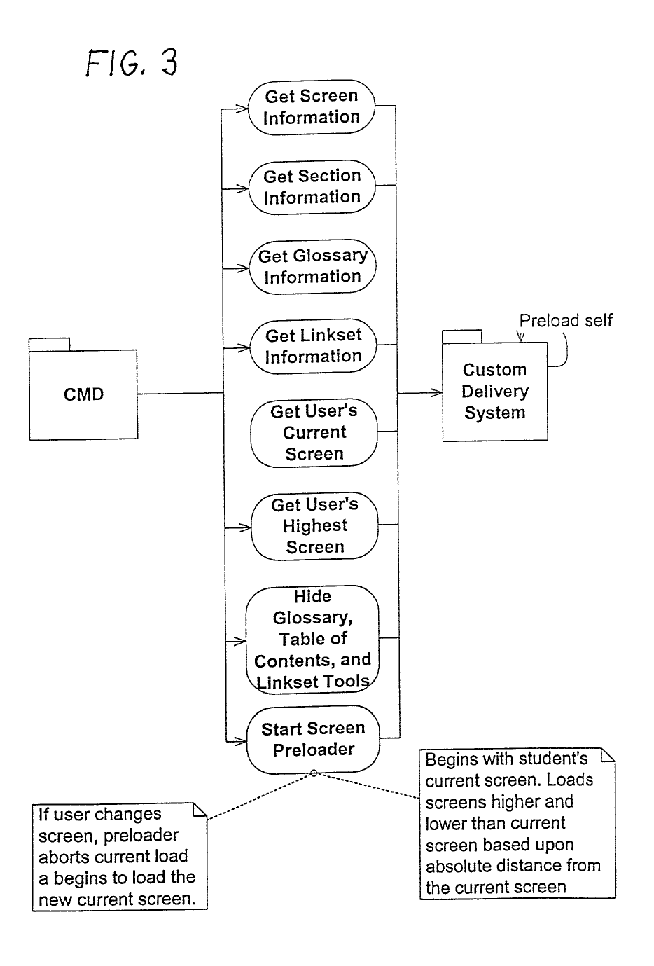

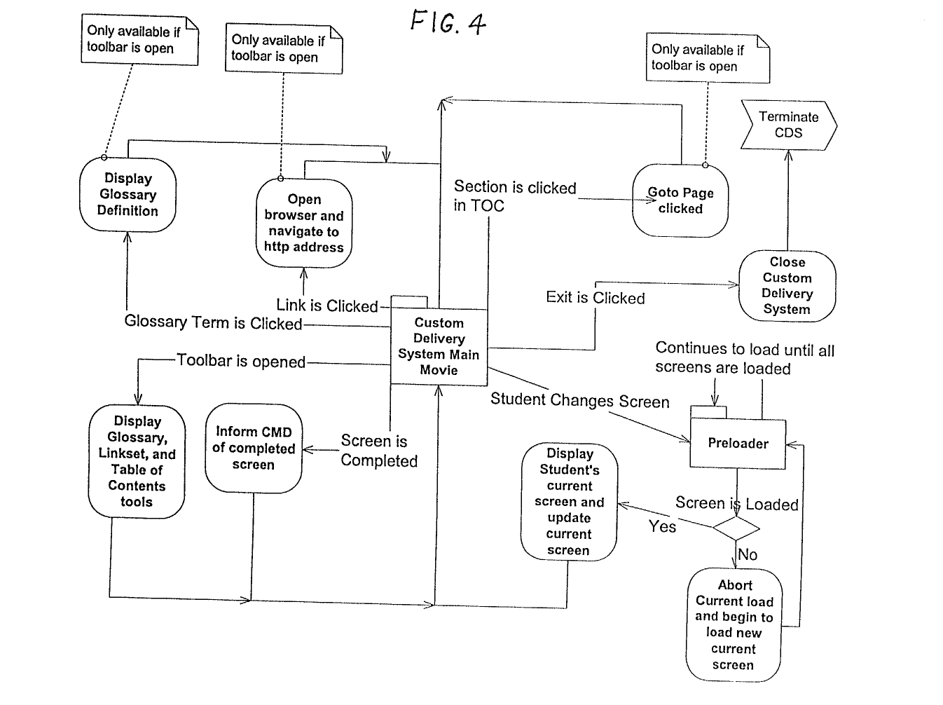

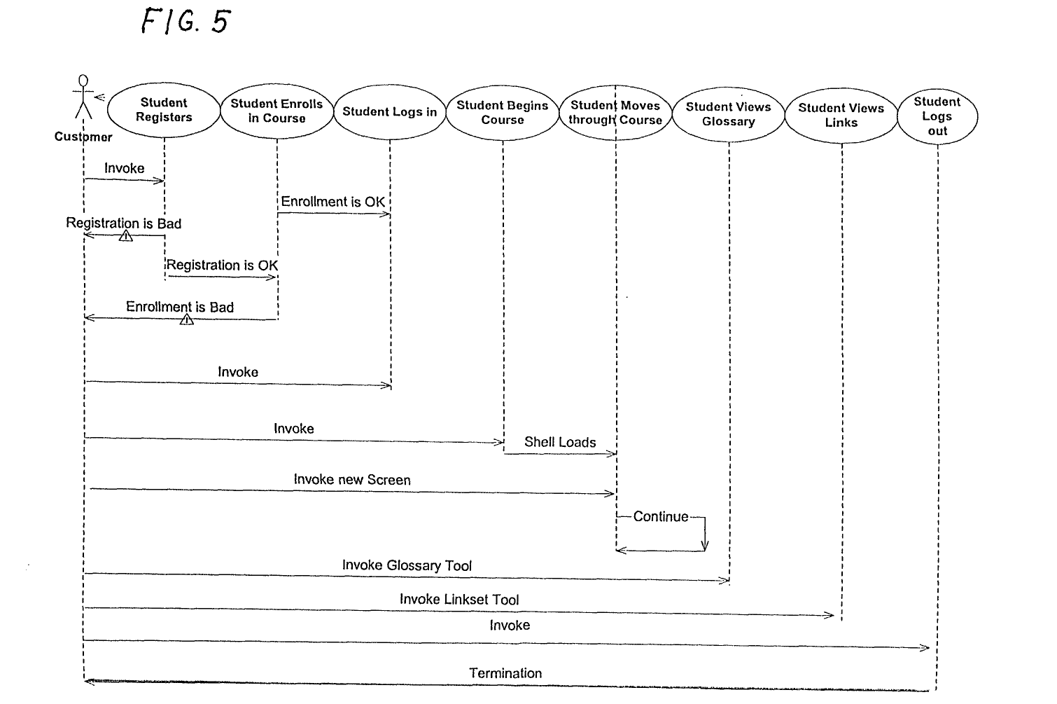

The following are principal features of the learning management system of the present invention. Access to the learning system is multithreaded for access of the database is provided whereby multiple participant user computers 12 may simultaneously access and participate in the dynamic stored interactive experiences. Broad navigation capabilities are provided in the host computer system 11 whereby a participant user may selectively navigate the host learning system, including the database 16. An additional important feature of the present invention is that the host computer 11 is further programmed whereby a participant user may exit participation at any desired time and will be automatically returned to the place of termination upon re-accessing the website by the participant user for continued participation. The remaining FIGS. 3, 4 and 5 are flow charts that illustrate to a programmer of ordinary skill in the art how these features can be programmed into the host computer system 11.

There are three major tools used to create the online learning management system of the present invention, a global computer network, such as the World Wide Web, a server-side scripting language that allows a global computer network server to create dynamically generated web pages, and thirdly, a tool for graphic artists to easily create vector-based tweened animation. These tools are used such that the sequences of screens can be combined with other similar sequences to create a robust online learning environment. The course is also designed and programmed to have the following technical characteristics:

1.—A shell or Custom Delivery System (CDS) that delivers the course requested by the user.

2.—The student may access any registered course at any time.

3.—The student may exit the course at any time.

4.—The course will track the last page viewed by the student.

5.—Upon reentry, the student will be returned to the page last viewed.

6.—The student may review any screen.

7.—The course is multithreaded whereby multiple students may simultaneously access the same course material.

Each screen will independently express one or more concise concepts. Sequences will consist of a series of the screens in such a way that a broader concept is relayed to the student. Finally, all the sequences merge to express the general subject being taught by the course.

In the preferred embodiment of the present invention being explained, the server-side scripting language that is employed in the system of the present invention in order to allow the host computer system to create dynamically generated web pages is a marketed program sold under the mark ColdFusion and it is used also to communicate with the Custom Delivery System (CDS). Flash is a tool designed for graphic artists to easily create vector-based tweened animation and for the design of the present invention. This tool is a program marketed under the mark Macromedia Flash.

As explained, the three major tools used to create the online system of the present invention are the global computer network, ColdFusion and Macromedia Flash. As explained, ColdFusion is the trademark for a server-side scripting language that allows a global computer network server to create dynamically generated web pages. ColdFusion is also used to communicate with the Macromedia Flash shell. This communication allows the programmer to deliver dynamic Flash content, tracking the use of Flash content, and providing Flash content in a way that the student is unaware that they are viewing small portions of Flash animation placed end to end.

Macromedia Flash is a trademark for a program designed as a tool for graphic artists to easily create vector-based tweened animation. Vector animation provides a high quality to low size ratio from which Flash gains its reputation. Tweened animation is the process wherein an artist creates key frames that denote changes in the animation and other subordinate artists fill in the tween frames (“in-between frames”). Flash takes on the role of the subordinate artist in that it creates the tween frames for animation. Flash was also provided with a very limited programming language called Action Script that was designed to give graphic artists the ability to control the flow of their animation. The present inventors utilize the features of Action Script well beyond its intended purpose. The result is an online learning system that will function such that any user regardless of platform may access and utilize the course material through a low bandwidth connection.

The Custom Delivery System (CDS) interacts with the host database to retrieve information, add information by interacting with ColdFusion scripts and to update information by interacting with ColdFusion scripts. The CDS also preloads all the movies associated with the course. This is done by loading screens as the student is viewing the current screen. The CDS also loads a series of glossary terms and definitions associated with the course and loads a set of http addresses associated with the course.

The host database further tracks the user's current position, tracks the user's highest obtained position, reports screen completion to the host database and allows the course to flow nonstop due to background loading of content.

Any one of these specifically named actions has been previously attempted in the prior art in Flash individually. However, a self-contained, fully dynamic, scalable Flash shell that simultaneously provides all of the above functions, has not been heretofore created and the present inventors thus utilize the Flash Action script well past its general expectations and purpose.

The learning management system of the present invention may be beneficially operated for the benefit of outside independent reporting companies that contract with the host provider for a designated number of course hours and a designated number of students. The reporting company then provides the host provider with identifying numbers for the students that are in turn inserted into the learning management database 16. The student can then register over the global computer network with the host computer system 11 using the provided identification number previously registered by the reporting company. A new account is then created for the user in the learning management database 16. The student can then enroll in a course of their choosing from a list of courses purchased by the reporting company and upon enrollment, an enrollment record is created in the host database for the student

We claim:

1. A computer implemented method of providing self directed online interactive experiences such as learning or game playing by multiple participants on user general purpose computers having a memory device and a display device, the user computers being coupled to a computer network, the computer implemented method comprising:
storing a database of interactive experiences in a storage medium of a remote host computer coupled to the network, said host computer having web server capabilities;
multithreading the access of said database whereby multiple participant users of general purpose computers may simultaneously access and participate in selected ones of the stored interactive experiences;
providing navigation capabilities in the host computer whereby a participant user on a user general purpose computer may selectively navigate a host management system programmed into the host computer, and
accessing a desired interactive experience from the interactive experiences stored in the host database with at least one of the user general purpose computers over the network and displaying it in a screen of the display device of the at least one user computer for interactive participation in the experience by a participant user.

2. The computer implemented method of claim 1 including providing index capabilities in the host computer whereby a participant user may exit participation at any desired time and will be automatically returned to the place of termination upon re-accessing the database by the participant user for continued participation.

3. The computer implemented method of claim 2 wherein said interactive experiences are learning experiences for a learning management system and accessing includes accessing at least one course component learning experience selected from the group consisting of learn, complete course work, demonstrate knowledge, self evaluation and share course work.

4. The computer implemented method of claim 3 wherein accessing the learn component of the course component learning experiences includes accessing at least one course section selected from the group consisting of course objective outline, provision of learning materials, tools for navigating selected portions of the host computer learning management system and display of concepts.

5. The computer implemented method of claim 4 wherein accessing display of concepts includes accessing at least one of the display of concepts selected from the group consisting of an engaging interaction, a web site visit, a real-world simulation, hard copy documentation and electronic collaborative communications.

6. An apparatus for providing self-directed online interactive experiences such as learning or game playing by multiple participants comprising:
a host computer system coupled to a computer network and having a storage medium storing a database of interactive experiences and programmed with a delivery management system;
a plurality of user general purpose computers coupled through the network to the host computer system for displaying user selected interactive experiences from the host computer management system for interactive user participation in a selected experience;
said host computer system programmed for multithreaded access of the host management system whereby multiple participant user computers may simultaneously access and participate in selected ones of the stored interactive experiences; and
said host computer system further programmed for providing navigation capabilities in the host computer system whereby a participant user may selectively navigate the host management system on a participant user computer.

7. The apparatus of claim 6 wherein said host computer system is further programmed for providing index capabilities in the host computer system whereby a participant user may exit participation at any desired time and will be automatically returned to the place of termination upon re-accessing of the database by the participant user for continued participation.

8. The apparatus of claim 7 wherein said interactive experiences are learning experiences for a learning management system and wherein said learning experiences are at least one course component experience selected from the group consisting of learn, complete course work, demonstrate knowledge, self-evaluation and share course work.

9. The apparatus of claim 8 wherein the learn component of the course component learning experiences includes at least one course section selected from the group consisting of course objective outline, provision of learning materials, tools for navigating selected portions of the host computer learning management system and display of concepts.

10. The apparatus of claim 9 wherein course section display of concepts includes at least one of the display concepts selected from the group consisting of an engaging interaction, a web site visit, a real-world simulation, hard copy documentation and electronic collaboration communication.

11. A storage medium encoded with machine-readable computer program code used in a host computer system for remote participation in online interactive experiences such as learning or game playing by multiple participants, the storage medium programmed for multithreaded access of a database of the host computer system whereby multiple online participant user computers may simultaneously access and participate in selected stored interactive dynamic experiences, and further programmed for providing navigation capabilities in the host computer system whereby a participant user may selectively navigate the database with an online user computer.

12. The encoded storage medium of claim 11 wherein the storage medium is programmed for providing index capabilities whereby a participant user may exit participation on an online user computer at any desired time and will be automatically returned to the place of termination upon re-accessing the database by the participant user for continued participation.
